(19) United States
(12) Patent Application Publication
(10) Pub. No.: US 2012/0161920 A1
(43) Pub. Date: Jun. 28, 2012

(54) BIMETAL ASSEMBLY FOR CIRCUIT BREAKER

(75) Inventor: Bon Geun KOO, Cheongju (KR)

(73) Assignee: LSIS CO., LTD, Anyang (KR)

(21) Appl. No.: 13/335,865

(22) Filed: Dec. 22, 2011

(30) Foreign Application Priority Data
Dec. 28, 2010 (KR) 20-2010-0013504

(51) Int. Cl. H01H 37/52

(52) U.S. Cl. 337/372

(57) ABSTRACT

A bimetal assembly includes: a heater connected to a movable contact to be provided with power; and a bimetal having one end portion coupled to the heater and disposed to be spaced apart from the heater, wherein the heater includes: a coupling portion coupled to the bimetal; a separation portion spaced apart by a certain distance from the bimetal; and a connection portion connecting the coupling portion and the separation portion, wherein at least one projection is formed to be protruded from the separation portion toward the bimetal.

The present disclosure relates to subject matter contained in priority Korean UM. Application No. 20-2010-0013504, filed on Dec. 28, 2010, which is herein expressly incorporated by reference in its entirety.

### FIELD OF THE INVENTION

The present invention relates to a bimetal assembly for a circuit breaker and, more particularly, to a bimetal assembly initiating a trip operation when a fault current is generated in a circuit breaker.

### DESCRIPTION OF THE RELATED ART

A circuit breaker, which is formed by integrally assembling an ON/OFF device, a tripping device, and the like, within a container made of a material having electrically insulating characteristics, can open or close a power line in an electrically connected state manually or through electrical manipulation and break a current to protect a wiring in the event of an error such as an overload, a short-circuit, or the like.

In general, a circuit breaker refers to a molded case circuit breaker (MCCB) used for protecting a low pressure power line of an AC 600V or lower or a DC 250V or lower. The circuit breaker is fabricated to be compact, simply manipulated, and does not involve user inconvenience of maintenance such as changing a fuse, or the like, so it is commonly used in the place of the conventional knife switch and a fuse.

Trip devices include a bimetal type trip device in which a bimetal is heated by a current flowing through a circuit breaker so as to be bent to perform a trip operation, an electromagnetic field type trip device in which a current allows to a coil provided in a circuit breaker, and in this case, when an overcurrent is applied, a core is attracted by an electromagnetic field formed around the coil, to interrupt or break current (or perform trip operation), and an electronic type trip device employing a microprocessor.

Among them, the bimetal type trip device performs a trip operation by using a bimetal assembly including a heater and a bimetal deformed by heat generated by the heater. FIG. 1 illustrates an example of a circuit breaker employing such a bimetal assembly. With reference to FIG. 1, the circuit breaker includes a trip device 200 installed within a main body 110 and tripping an overcurrent or a short current, an ON/OFF device 130 including a plurality of links to connect an actuator (or a mover) 150 to a stator (not shown) of a power source or disconnect (or separate) it from the stator, and an alarming device 140 interworking with the ON/OFF device 130 to display presence or absence of an overcurrent or a short-circuit accident.

The ON/OFF device 130 includes a handle 131 rotatably supported by the main body 110, a latch 132 connected to the handle 131 and displaced according to a rotation of the handle 131 to move the actuator 150, a latch holder 133 connected to the latch 132 and constraining the operation of the latch 132, a driving pine 134 connected to the latch holder 133 and moving according to a movement of the latch holder 133, and a cross bar 135 constraining the latch holder 133.

The trip device 200 disposed at one side of the cross bar 135 includes a heater 210 connected to the power source side (e.g., the stator (not shown) or the actuator 150) of the circuit breaker to receive power and a bimetal 230.

The bimetal 230, in a state of being in contact with a lower end portion of the heater 210, is fixed to the lower end portion of the heater 210 by a fixing bolt, and is bent when an overcurrent or a short current is applied to the circuit breaker. When the bimetal 210 is bent, a contact piece 232 formed at an end portion thereof pushes the cross bar 135 to open the ON/OFF device 130.

Here, since the heater 210 and the bimetal 230 are spaced apart as illustrated, due to tolerance in an assembling process for assembling the bimetal assembly or in case of a long-time use, the bimetal 230 is deformed, or the like, causing a problem in which the space between the bimetal 230 and the heater 210 becomes non-uniform. In particular, in the circuit beaker having multiple phases, the space between the bimetal and each pole is non-uniform, the breaking characteristics of the circuit breaker become non-uniform.

### SUMMARY OF THE INVENTION

An aspect of the present invention provides a bimetal assembly capable of maintaining a space between a bimetal and a heater.

According to an aspect of the present invention, there is provided a bimetal assembly including: a heater connected to a movable contact to be provided with power; and a bimetal having one end portion coupled to the heater and disposed to be spaced apart from the heater, wherein the heater includes: a coupling portion coupled to the bimetal; a separation portion spaced apart by a certain distance from the bimetal; and a connection portion connecting the coupling portion and the separation portion, wherein at least one projection is formed to be protruded from the separation portion toward the bimetal.

According to another aspect of the present invention, there is provided a bimetal assembly including: a heater connected to a movable contact to be provided with power; and a bimetal having one end portion coupled to the heater and disposed to be spaced apart from the heater, wherein the heater includes: a coupling portion coupled to the bimetal; a separation portion spaced apart by a certain distance from the bimetal; and a connection portion connecting the coupling portion and the separation portion, wherein at least one projection is formed to be protruded from a portion of the bimetal facing the separation portion, toward the separation portion.

According to embodiments of the present invention, since projections are formed to be provided from any one of the bimetal or the heater, a space between the bimetal and the heater can be maintained at a minimum level or greater.

Here, a plurality of projections may be disposed in a lengthwise direction of the separation portion or the bimetal, and end portions of the projections may be spaced apart from the bimetal or the separation portion.

Thus, since the space between the bimetal and the heater is maintained to have a minimum level or larger in spite of erroneous assembling, assembling tolerance, or a long-term use, reliability and a life span of the device can be enhanced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an example of a circuit breaker employing a general bimetal assembly according to the related art.

FIG. 2 is a view, equivalent to FIG. 1, illustrating a circuit breaker employing a bimetal assembly according to an embodiment of the present invention.

### DETAILED DESCRIPTION OF THE INVENTION

A circuit breaker according to an embodiment of the present invention will be described with reference to the accompanying drawing.

Hereinafter, a bimetal assembly according to an embodiment of the present invention will be described with reference to the accompanying drawing.

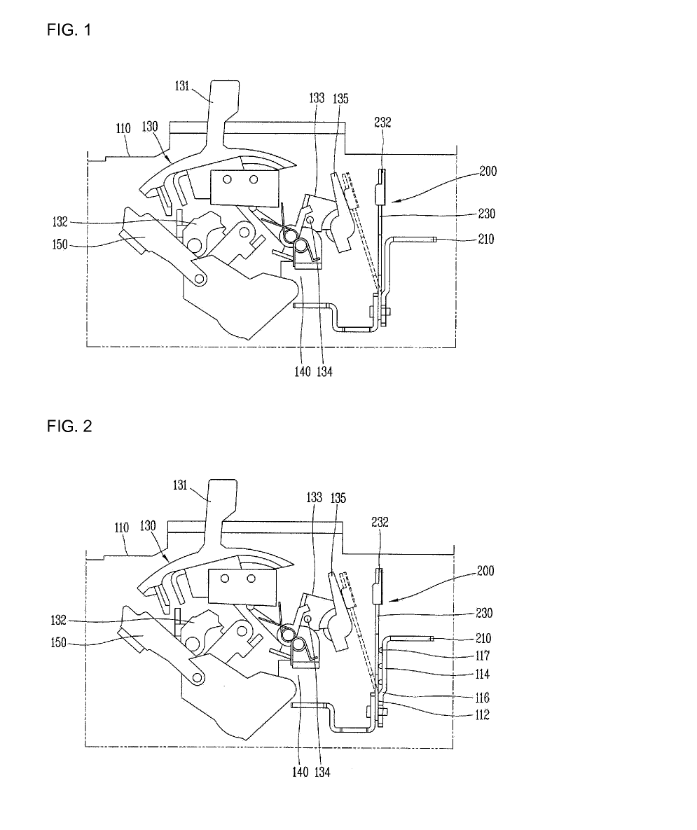

FIG. 2 is a view, equivalent to FIG. 1, illustrating a circuit breaker employing a bimetal assembly according to an embodiment of the present invention. With reference to FIG. 2, a circuit breaker 100 according to an embodiment of the present invention includes a heater 210 and a bimetal 230. The heater 210 is formed by bending a member having a plate-like shape a plurality of times, and includes a coupling portion 112 formed at a lower portion thereof and coupled to the bimetal 230 and a separation portion (or a clearance portion) 114 positioned at an upper side of the coupling portion 112. The coupling portion 112 and the separation portion 114 are connected by a connection portion 116. Here, the coupling portion, the separation portion, and the connection portion are discriminated to be referred for the sake of explanation, and in actuality, the coupling portion 112, the separation portion 114, and the connection portion 16 are integrally formed.

As shown in FIG. 2, the connection portion 116 is bent to the right. Thus, as a result, the separation portion 114 is positioned to be separated rightwardly in comparison to the coupling portion 112. The bimetal 230 is fixed to the coupling portion 112. In detail, a lower end portion of the bimetal 230, in contact with the coupling portion 112, is firmly fixed by a bolt, or the like, and based on the coupling point, the bimetal 230 can be bent to be moved in both directions.

Here, three projections 117 are formed on a surface of the separation portion 114. The projections 117 are disposed to be spaced apart at certain intervals along a lengthwise direction and protruded toward the bimetal 230. Here, the length of the projections 117 is equivalent to a minimum value within an appropriate space range between the bimetal 230 and the separation portion 114, and in a normal state, the bimetal 230 and the projections 117 are maintained in a state in which they are not in contact.

Due to the presence of the projections 117, the space between the bimetal 230 and the separation portion 114 can be maintained to have at least an appropriate minimum level. In addition, since a plurality of projections 117 are disposed in the lengthwise direction of the separation portion 114, the bimetal 230 can be maintained at a uniform interval on the whole. Thus, although the bimetal 230 is deformed due to tolerance during an assembling operation or a frequent operation or actuation, because it is in contact with the projections 117, an appropriate level of space can be constantly maintained therebetween.

Meanwhile, the present invention is not necessarily limited to the foregoing embodiments, and an example in which the projections are formed on the bimetal, rather than on the separation portion may be considered. Here, the projections may be formed on a portion of the bimetal facing the separation portion.

What is claimed is:

1. A bimetal assembly comprising:
a heater connected to a movable contact to be provided with power; and
a bimetal having one end portion coupled to the heater and disposed to be spaced apart from the heater,
wherein the heater comprises:
a coupling portion coupled to the bimetal;
a separation portion spaced apart by a certain distance from the bimetal; and
a connection portion connecting the coupling portion and the separation portion,
wherein at least one projection is formed to be protruded from the separation portion toward the bimetal.

2. The bimetal assembly of claim 1, wherein a plurality of projections are disposed in a lengthwise direction of the separation portion.

3. The bimetal assembly of claim 1, wherein end portions of the projections are spaced apart from the bimetal.

4. A bimetal assembly comprising:
a heater connected to a movable contact to be provided with power; and
a bimetal having one end portion coupled to the heater and disposed to be spaced apart from the heater,
wherein the heater comprises:
a coupling portion coupled to the bimetal;
a separation portion spaced apart by a certain distance from the bimetal; and
a connection portion connecting the coupling portion and the separation portion,
wherein at least one projection is formed to be protruded from a portion of the bimetal facing the separation portion, toward the separation portion.

5. The bimetal assembly of claim 4, wherein a plurality of projections are disposed in a lengthwise direction of the bimetal.

6. The bimetal assembly of claim 4, wherein end portions of the projections are spaced apart from the separation portion.
